(19) United States
(12) Patent Application Publication
(10) Pub. No.: US 2026/0010139 A1
(43) Pub. Date: Jan. 8, 2026

(54) EQUIPMENT ANOMALY WARNING SYSTEM AND METHOD

(71) Applicant: Delmind Inc., Taoyuan City (TW)

(72) Inventors: KUANG PING TSENG, Taoyuan City (TW); SHAO TING LO, Taoyuan City (TW)

(21) Appl. No.: 19/089,381

(22) Filed: Mar. 25, 2025

(30) Foreign Application Priority Data
Jul. 3, 2024 (CN) 202410885314.8

(51) Int. Cl. G05B 19/4065

(52) U.S. Cl. CPC G05B 19/4065; G05B 2219/34491

(57) ABSTRACT

Equipment anomaly warning systems and methods are disclosed and used for acquiring a set of sensing parameters of a piece of equipment, evaluating a stage-specific anomaly count threshold for the equipment based on the set of sensing parameters, and detecting a cumulative anomaly count based on the set of sensing parameters to send a warning signal based on a comparison between the cumulative anomaly count and the stage-specific anomaly count threshold. In this way, it can more accurately identify equipment anomalies needed to warn and reduce misjudgments or omissions of anomalies compared with technologies that use a fixed mechanism to detect anomalies.

### CROSS REFERENCE TO RELATED APPLICATIONS

This application claims the priority of China Patent Applications No. 202410885314.8, titled “EQUIPMENT ANOMALIES WARNING SYSTEM AND METHOD,” filed on Jul. 3, 2024, the disclosures of which are incorporated herein by reference.

### FIELD OF THE INVENTION

The present disclosure relates to the technical field of equipment warning, specifically to equipment anomaly warning systems and methods.

### BACKGROUND OF THE INVENTION

Whether equipment anomalies can be detected promptly and accurately affects production costs and product quality during the use of industrial process equipment. However, when normal and abnormal equipment cannot be accurately identified, for example, misjudgments of equipment anomalies will increase the chance of process interruption, while omissions of equipment anomalies may lead to the risk of products not meeting specifications, resulting in pressure on production schedules, loss in production efficiency, or negative impact on reputation. Although there have been some equipment anomaly detection technologies in the past, they still need to be improved.

### SUMMARY OF THE INVENTION

An object of the present disclosure is to provide equipment anomaly warning systems and methods that effectively identify equipment anomalies requiring an alarm.

To achieve the above object, one aspect of the present disclosure provides an equipment anomaly warning system, which includes: a sampling module configured to acquire a set of sensing parameters of a piece of equipment; an evaluation module coupled to the sampling module, wherein the evaluation module is configured to evaluate a stage-specific anomaly count threshold for the equipment based on the set of sensing parameters; and a determination module coupled to the sampling module and the evaluation module, wherein the determination module is configured to detect a cumulative anomaly count based on the set of sensing parameters to send a warning signal based on a comparison between the cumulative anomaly count and the stage-specific anomaly count threshold.

To achieve the above object, one aspect of the present disclosure provides a piece of equipment anomaly warning method, which is applied to a system that includes a processor that is configured to execute the method, which includes: acquiring a set of sensing parameters of a piece of equipment; evaluating a stage-specific anomaly count threshold for the equipment based on the set of sensing parameters; and detecting a cumulative anomaly count based on the set of sensing parameters to send a warning signal based on a comparison between the cumulative anomaly count and the stage-specific anomaly count threshold.

The equipment anomaly warning system and method of the present disclosure are provided for acquiring the set of sensing parameters of the equipment, evaluating the stage-specific anomaly count threshold for the equipment based on the set of sensing parameters, and detecting the cumulative anomaly count based on the set of sensing parameters to send the warning signal based on the comparison result of the cumulative anomaly count and the stage-specific anomaly count threshold. In this way, dynamic anomaly detection is performed based on the overall operating condition of the equipment (e.g., its health status), and equipment's usage stage (such as its life cycle) is evaluated based on sensor data from the equipment to dynamically adjust the sensitivity of the anomaly warning. For example, appropriate alarm thresholds can be set according to different periods to more accurately identify equipment anomalies that require a warning, helping to reduce misjudgments or omissions of anomalies.

### BRIEF DESCRIPTION OF THE DRAWINGS

FIG. 1 is a block diagram illustrating an equipment anomaly warning system provided in an embodiment of the present disclosure.

FIG. 2 is a schematic diagram illustrating an application scenario of an equipment anomaly warning system, applied to sensing vibration in a high-pressure reactor, provided in an embodiment of the present disclosure.

FIG. 3 is a schematic diagram illustrating an application scenario of an anomaly warning mechanism used in an embodiment of the present disclosure.

FIG. 4 is a schematic diagram illustrating a human-machine interface, used to display current information of equipment, provided in an embodiment of the present disclosure.

FIG. 5 is a schematic flowchart illustrating an equipment anomaly warning method provided in an embodiment of the present disclosure.

### THE DETAILED DESCRIPTION OF PREFERRED EMBODIMENTS

To make the above and other objects, features, and advantages of the present disclosure more apparent and understandable, preferred embodiments of the present disclosure will be described in detail below along with the accompanying drawings.

If an anomaly warning mechanism primarily depends on status characteristics of critical signals (such as offsets) in industrial process equipment, for example, a warning signal is sent when a sensing measurement exceeds an anomaly threshold or the number of anomalies exceeds a predefined count threshold, then the overall operational profile of the equipment is not fully considered. For example, trends in sensing characteristics vary across different usage stages (i.e., phases of the equipment's lifecycle) are different. If, for instance, a fixed threshold based on the equipment's middle stage is used for anomaly warning mechanism, because during the equipment's early (running-in) stage, the stability of critical signals is low—leading to frequent false alarms—while in its late (wear) stage, anomalies may be overlooked. Therefore, there is a need to improve the above situation.

In one aspect, embodiments of the present disclosure provide an equipment anomaly warning system, which includes a sampling module configured to acquire a set of sensing parameters of a piece of equipment; an evaluation module coupled to the sampling module, wherein the evaluation module is configured to evaluate a stage-specific anomaly count threshold for the equipment based on the set of sensing parameters; and a determination module coupled to the sampling module and the evaluation module, wherein the determination module is configured to detect a cumulative anomaly count based on the set of sensing parameters to send a warning signal based on a comparison between the cumulative anomaly count and the stage-specific anomaly count threshold.

In this way, dynamic anomaly detection is performed based on the overall operating condition of the equipment (e.g., its health status), and equipment's usage stage (such as its life cycle) is evaluated based on sensor data from the equipment to dynamically adjust the sensitivity of the anomaly warning, such as giving appropriate anomaly warning thresholds according to different usage stages to more accurately identify equipment anomaly situations that require a warning, thereby reducing false alarms or omissions of anomalies. Examples are given below, but are not limited to the description here.

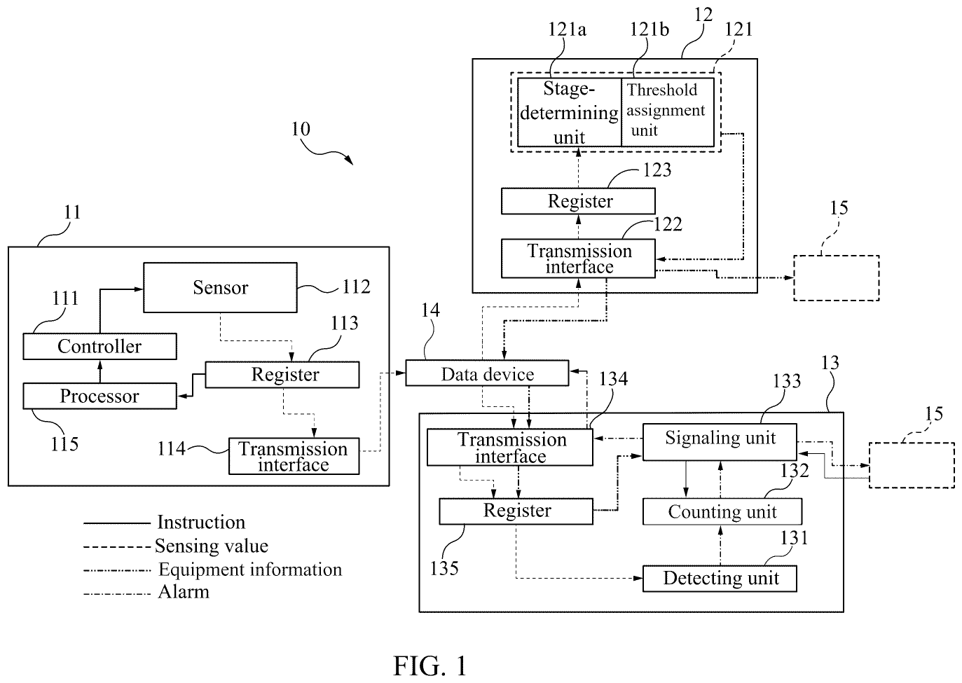

For example, as shown in FIG. 1, an equipment anomaly warning system 10 includes a sampling module 11, an evaluation module 12, and a determination module 13. The evaluation module 12 is coupled to the sampling module 11. The determination module 13 is coupled to both the sampling module 11 and the evaluation module 12. The sampling module 11 is configured to acquire a set of sensing parameters from a piece of equipment (such as various types of process equipment), such as various sensing values that can be used to assess the aging condition of the entire equipment or its individual components. The evaluation module 12 is configured to evaluate a stage-specific anomaly count threshold for the equipment based on the set of sensing parameters. The determination module 13 is configured to detect a cumulative anomaly count based on the set of sensing parameters to send a warning signal based on a comparison between the cumulative anomaly count and the stage-specific anomaly count threshold. The equipment anomaly warning system 10 can be configured in various forms according to usage requirements, for example, by including instructions, sensing values, equipment information, and alarm-related signals.

In some embodiments, as shown in FIG. 1, the equipment anomaly warning system 10 also includes a data device 14. The data device 14 is configured to store the set of sensing parameters, stage-specific anomaly count thresholds, and warning signals. The sampling module 11, the evaluation module 12, and the determination module 13 include a transmission interface 114, 122, and 134, respectively. The transmission interfaces 114, 122, and 134 are communicatively coupled to the data device 14.

For example, as shown in FIG. 1, the sampling module 11, the evaluation module 12, and the determination module 13 can be multiple electronic devices dispersed across different locations. These electronic devices can operate cooperatively through hardware-software co-design, or individual functions may be implemented on separate application-specific integrated circuits that work together. Further, these electronic devices can transmit data to each other through wired or wireless networks or other communication methods, such as storing and exchanging data through data device 14 (e.g., cloud data platforms or servers), but not limited to the description here.

Alternatively, the sampling module 11, the evaluation module 12, and the determination module 13 can also be integrated into a data processing machine, such as various computers or computing platforms. For example, the data processing machine can include a processor and a memory storing instructions. When the processor executes the instructions, the sampling module 11, the evaluation module 12, and the determination module 13 are instantiated, and their functionality for cooperating with related equipment (such as data equipment and human-machine interface) are instantiated. In addition, the data device 14 may be a non-transitory storage medium, such as a hard disk drive (HD) or a solid-state drive (SSD) but is not limited thereto.

In some embodiments, as shown in FIG. 1, the sampling module 11 includes a controller 111 and at least one sensor 112. The controller 111 can be configured to control the sensor 112 to measure one or more sensing values from a piece of equipment (such as a piece of petrochemical process equipment but not limited to the description here) to form a set of sensing parameters. For example, the set of sensing parameters may include a plurality of discrete-time sensing parameters but is not limited to the description here. In other embodiments, the sampling module 11 includes a plurality of sensors 112, wherein each sensor 112 is provided with its own controller 111.

In some embodiments, as shown in FIG. 1, the set of sensing parameters may include a plurality of discrete-time sensing parameters that represent aging sensing factors of the equipment. For example, the set of sensing parameters may comprise at least one of the following: a vibration value, a stress value, a torque value, a pressure value, and a temperature value, or any combination thereof. The set of sensing parameters can be directly transmitted to other electronic devices, such as the evaluation module 12, the determination module 13, and the data device 14, but is not limited to the description here. The set of sensing parameters can also be stored in a register 113 (such as a memory); the sensing values can also be sent to other electronic devices through the transmission interface 114 (such as a wired or wireless communication transceiver). The register 113 can also store at least one instruction (or program). For example, when a processor 115 executes the stored instructions, the controller 111 can be configured to operate in different operating modes, such as performing an adaptive sampling process for different equipment's aging sensing factors.

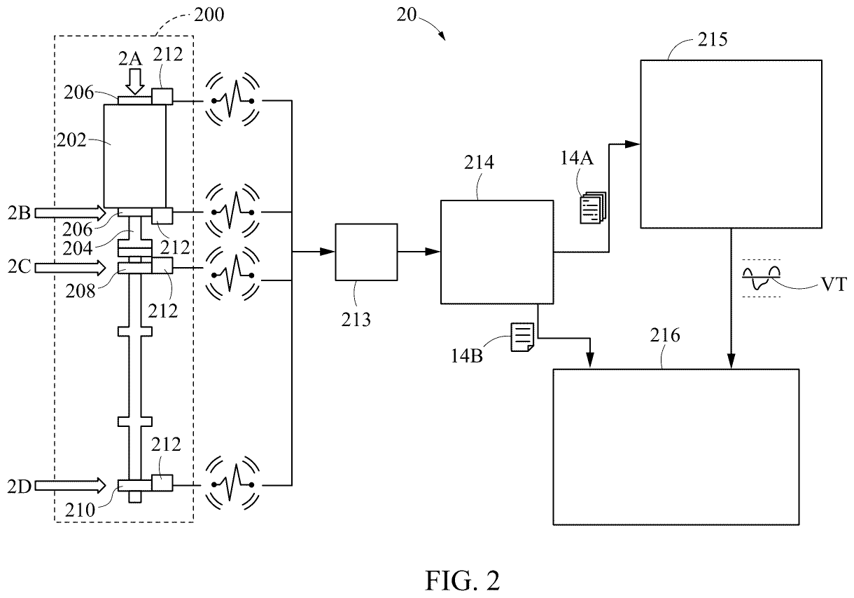

For example, as shown in FIG. 2, an application scenario 20 illustrates an embodiment of the equipment anomaly warning system applied to sensing vibration in a high-pressure reactor. In this embodiment, a plurality of vibration sensors 212 are installed on surfaces of a piece of equipment 200. For example, the equipment 200 can be a high-pressure reactor, but it is not limited to the description here. The equipment 200 can also be industrial equipment used in the chemical industry. For example, the interior of the equipment 200 provides a high-pressure environment that facilitates various chemical reactions. In one example, the equipment 200 includes a motor 202 and a motor shaft 204. When the equipment 200 is in operation, the motor 202 is activated to drive the motor shaft 204, causing it to rotate. In some embodiments, the vibration sensors 212 can be disposed at bearings of the equipment 200, such as on surfaces of motor bearings 206 (at positions 2A and 2B), on a middle bearing 208 (at position 2C), and on a bottom bearing 210 (at position 2D), but is not limited to the description here.

In these embodiments, as shown in FIG. 2, the motor bearing 206 at position 2A is located on a top portion of the motor 202, and the vibration sensor 212 can effectively detect an amount of vibration generated when the motor 202 rotates (and generate an appropriate form of electrical signal representing a sensing value). The motor bearing 206 at the position 2B is located at a junction where the motor 202 is physically connected to the motor shaft 204, and the vibration sensor 212 can effectively detect the amount of vibration generated when the motor 202 and the motor shaft 204 rotate. The middle bearing 208 at position 2C is located in the middle portion of the motor shaft 204, and the vibration sensor 212 can effectively detect the amount of vibration generated when the motor shaft 204 rotates. The bottom bearing 210 at position 2D is located at the bottom portion of the motor shaft 204, and the vibration sensor 212 can effectively detect the amount of vibration generated when the motor shaft 204 rotates.

In these embodiments, as shown in FIG. 2, the sensing values (indicating the amount of vibration) of the vibration sensors 212 can also be converted from analog to digital by a data acquisition module (DAQ module) 213 to be stored in a data device 214. The data device 214 can then provide the set of sensing parameters (such as a plurality of discrete-time vibration sensing values 14A) to an evaluation module 215 to generate a vibration anomaly threshold VT. The data device 214 can also provide individual sensing values (such as real-time sensing data 14B) to a determination module 216 as a basis for subsequent determination of whether an alarm should be generated.

In one embodiment of the present disclosure, the equipment anomaly warning system may also assess a health profile of the equipment based on the sampling results (sensing values) to facilitate configuring the equipment's anomaly warning tolerance for different health conditions. Examples are provided as follows.

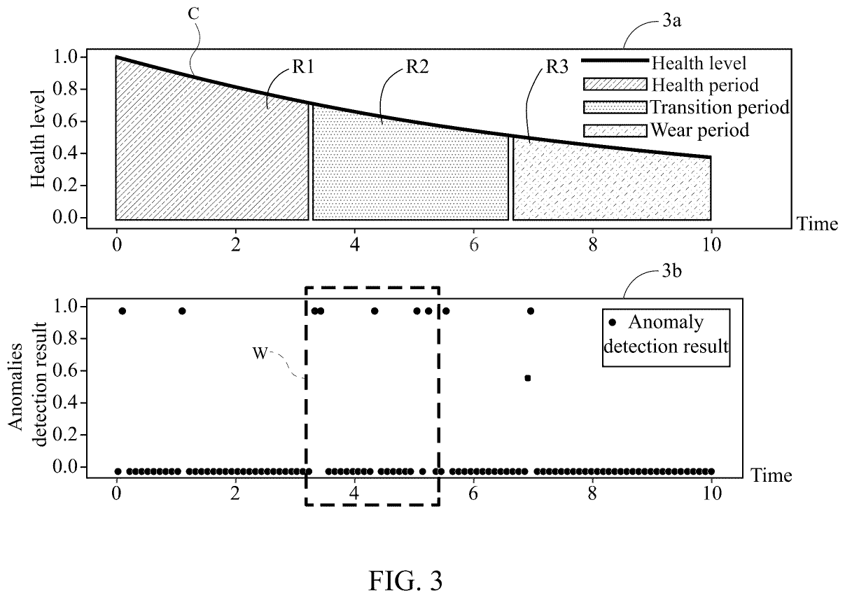

For example, FIG. 3 shows an example 3a of equipment health levels and an example 3b of anomaly detection results. It is assumed that an effective service life of a piece of equipment is normalized to a range from 0 to 10 units of time, which can be divided into a health period (such as an early stage of equipment) R1, a transition period (such as a middle stage of equipment) R2, and a wear period (such as a late stage of equipment) R3. A curve C indicates that a health degree of the equipment (such as the degree of equipment suitability for the use, which is normalized to be ranged from 0.0 to 1.0) decreases over time. The health degree of the health period R1 is highest, the health degree of the transition period R2 is intermediate, and the health degree of the wear period R3 is lowest.

For example, as shown in FIG. 3, suppose that the equipment has detected 2, 6, and 1 anomaly occurrences during the health period R1, transition period R2, and wear period R3, respectively. In such cases, an anomaly-tolerance window W (i.e., the allowable number of anomaly occurrences within a specific time period) can be set according to the piece of the equipment usage characteristics. In other words, the allowable number of anomaly occurrences can vary for different periods. Assume that the stage-specific anomaly count threshold for the equipment for the health period R1, the transition period R2, and the wear period R3 are 6, 4, and 2 occurrences, respectively. Namely, as the equipment's health deteriorates, resulting in the stage-specific anomaly count threshold decreases. That is, the anomaly tolerance becomes progressively tighter as the equipment advances through different stages, experiences a decline in health, or nears the end of its service lifecycle. This tightening is designed to prevent significant anomaly events from being overlooked during the later stages, thereby ensuring that the equipment's performance characteristics in each stage are properly met. Accordingly, if a cumulative anomaly count within the anomaly-tolerance window W is greater than the stage-specific anomaly count threshold of the current period, the anomalies are deemed to surpass the tolerance, thereby triggering an alarm. For example, if the cumulative anomaly count within the anomaly-tolerance window W is 5 occurrences during the transition period R2—exceeding its stage-specific anomaly count threshold of 4—then an alarm is triggered for the transition period R2. However, if, in the health period R1, the same cumulative anomaly count of 5 does not exceed the stage-specific anomaly count threshold of 6, no alarm is generated.

In this way, the anomaly warning mechanism of the embodiment of the present disclosure can adaptively and dynamically determine whether anomalies-counting results should trigger an alert according to the equipment stage; it can be applied to characteristic trends of different equipment stages, reducing the probability of misjudgment in the early equipment stage and the likelihood of missed alerts in the late equipment stage. Thus, the rationality and applicability of warning anomalies for the equipment can be effectively improved.

It should be understood that the embodiment of the present disclosure adopts a stage-specific anomaly count threshold (i.e., using different number-of-anomalies thresholds based on the equipment's different stages) to perform the anomaly warning mechanism. Compared with conventional warning thresholds that do not distinguish between stages, embodiments of the present disclosure can more accurately reflect anomaly occurrence trends during different periods of the equipment's lifecycle. In other words, the present disclosure can avoid issues such as using conventional warning thresholds—namely, failing to match the varying anomaly occurrence trends across different periods, which can lead to either missed detections or false alarms.

In some embodiments, as shown in FIG. 1, the evaluation module 12 includes an anomaly frequency setter 121. For example, the set of sensing parameters (such as sensing values) from the sampling module 11 can be received through the transmission interface 122 and stored in a register 123 but is not limited to the description here. The set of sensing parameters can also be directly transmitted to the anomaly frequency setter 121. The anomaly frequency setter 121 is configured to evaluate a stage-specific anomaly count threshold for the equipment, based on the set of sensing parameters, to serve as the number-of-anomalies threshold for the equipment during the current stage.

In some embodiments, as shown in FIG. 1, the anomaly frequency setter 121 includes a stage-determining unit 121a. The stage-determining unit 121a is configured to determine an equipment stage parameter based on an equipment model and the set of sensing parameters. For example, the set of sensing parameters is input into the equipment model. A model can be trained using historical data, or a pre-trained model may be used to assess an equipment profile (e.g., equipment usage stage). The equipment model is, for example, a time-series analysis model trained based on the set of sensing parameters of the equipment across several stages, such as a model trained based on one of algorithms, such as autoregression (AR), moving average (MA), autoregression moving average (ARMA), autoregression integrated moving average (ARIMA), and long short-term memory (LSTM) algorithms. According to the output results of the equipment model, the equipment stage parameter can be set to one of several usage stage codes of the equipment, such as 0x00 being a default value, 0x01 being an early stage (e.g., an equipment health stage), 0x02 being a mid-stage stage (e.g., an equipment transition stage), and 0x03 being a late stage (e.g., an equipment wear stage). Still, it is not limited to the description here.

In some embodiments, as shown in FIG. 1, the anomaly frequency setter 121 further includes a threshold assignment unit 121b. The threshold assignment unit 121b is configured to determine, e.g., set an anomaly count threshold (such as occurrences per period), based on equipment stage parameters, thereby establishing as the stage-specific anomaly count threshold applicable to the current equipment stage. For example, the number-of-anomalies thresholds of the equipment in the health stage R1, transition stage R2, and wear stage R3 are set to 6, 4, and 2 occurrences, respectively (collectively referred to as the stage-specific anomaly count threshold). The stage-specific anomaly count threshold can be regarded as part of equipment information and can be directly transmitted to other electronic devices, such as the determination module 13 or the data device 14, but is not limited to the description here. The stage-specific anomaly count threshold can be transmitted to other electronic devices through the transmission interface 122, serving as a basis for subsequent anomaly determination but is not limited to the description here. For example, the stage-specific anomaly count threshold can also be transmitted to a human-machine interface 15, such as an LCD monitor, a projector, or a screen of a mobile phone, to be displayed as part of a web page or an application (APP) of mobile phones, such as a graphical user interface (GUI).

In some embodiments, as shown in FIGS. 1 and 3, the stage-determining unit 121a of the anomaly frequency setter 121 of the evaluation module 12 predetermines a specific sensing value from an initial period of operation time, based on historical data of average normal-operation time of a model of a piece of target equipment, to serve as an equipment health period threshold to determine whether the equipment is in the early stage (i.e., the health period R1). For example, assuming that the historical data of the average normal-operation time of the model of the target equipment is one thousand days (meaning that the average period in operations from new to failure is 1000 days), then the evaluation module 12 calculates an average sensing value over the first 25% of the average normal-operation time (i.e., the first 250 days) and uses it as the equipment health period threshold to determine whether a piece of target equipment is in the early stage (i.e., the health period R1). In these embodiments, the aforementioned sensing value may be at least one or a combination of a vibration value, a stress value, a torque value, a pressure value, and a temperature value. A comparison of the target equipment's sensing parameters against the equipment health period threshold may be calculated and evaluated using standard deviation. For example, determining whether the set of sensing parameters of the target equipment fall within a range defined by the equipment health period threshold plus or minus three standard deviations. If so, the evaluation module 12 determines that the target equipment is in the early stage (i.e., the health period R1); otherwise, the evaluation module 12 determines whether the target equipment is in the middle stage (i.e., the transition period R2) or the late stage (i.e., the wear period R3) using a time-series analysis model (such as ARIMA).

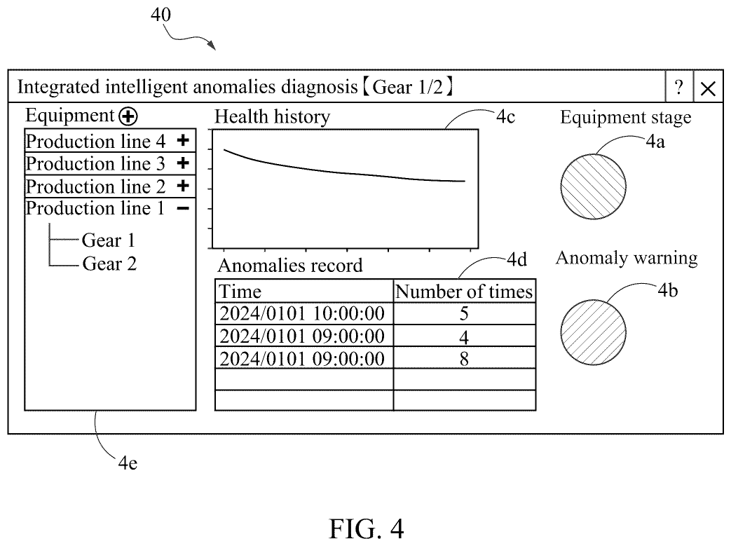

For example, as shown in FIG. 4, in example 40 of a graphical user interface, an integrated intelligent anomalies diagnosis screen is shown, which displays relevant information about “gear 1” and “gear 2”. For example, equipment-stage information can be represented by pattern 4a, in which white, gray, and black colors represent the early, middle, and late stages of equipment, respectively; anomaly-warning information can be represented by pattern 4b, such as red color indicating that a warning signal has been sent (e.g., when the cumulative anomaly count is higher than a tolerable level of the current stage); green color indicating that no warning signal is sent (e.g., when the cumulative anomaly count is lower than the tolerable level of the current stage). In addition, other relevant information can also be integrated into the screen, such as the equipment's health history curve 4c, anomaly record table 4d, and detection object identification form 4e, but is not limited to the description here.

In some embodiments, as shown in FIG. 1, equipment information (such as equipment stage parameters associated with stage-specific anomaly count thresholds) can be selectively displayed on the human-machine interface 15, thereby enabling the user to remotely monitor the equipment's status.

In some embodiments, as shown in FIG. 1, the determination module 13 includes a detecting unit 131, a counting unit 132, and a signaling unit 133. For example, a set of sensing parameters (such as sensing values) from the sampling module 11 and a stage-specific anomaly count threshold from the evaluation module 12 can be received by the transmission interface 134 and stored in a register 135 but is not limited to the description here. Alternatively, the set of sensing parameters and the stage-specific anomaly count threshold can also be directly transmitted to other functional units of the determination module 13.

For example, as shown in FIG. 1, the detecting unit 131 is configured to determine whether an anomaly state has occurred by evaluating a plurality of discrete-time sensing parameters from the set of sensing parameters and an anomaly threshold (such as a threshold that determines a specific characteristic value of the equipment as an anomaly), e.g., if a detected vibration value is greater than a vibration anomaly threshold (such as 5 mm/s), it is determined as a vibration anomaly state.

For example, as shown in FIG. 1, the counting unit 132 is configured to accumulate the number of times an anomaly state occurs in a period as a cumulative anomaly count. For instance, within a period (such as two hours), the anomaly state may occur five times (as an example but not limited thereto).

For example, as shown in FIG. 1, the signaling unit 133 can also send an instruction to the counting unit 132 to obtain information associated with determining whether to send an alarm (such as the cumulative anomaly count). The signaling unit 133 is configured to determine whether the cumulative anomaly count exceeds the stage-specific anomaly count threshold; if this condition is met, the warning signal is sent; otherwise, no warning signal is sent. The warning signal can be sent to other electronic devices, such as the data device 14 and/or the human-machine interface 15, for storage and/or display. Still, it is not limited to the description here. Moreover, the human-machine interface 15 can also be used to accept instructions input by a user and transfer instructions to the signaling unit 133, allowing the fine-tuning of the warning signal's issuance.

In some embodiments, as shown in FIG. 1, alarm information (such as warning signals) may be displayed on the human-machine interface 15. Thereby, it is convenient for the user to operate the human-machine interface to monitor an overview of the equipment remotely.

In another aspect, embodiments of the present disclosure provide an equipment anomaly warning method, which is applied to a system that includes a processor that is configured to execute the method, including: obtaining a set of sensing parameters of a piece of equipment; evaluating a stage-specific anomaly count threshold for the equipment based on the set of sensing parameters; and detecting a cumulative anomaly count based on the set of sensing parameters and issuing a warning signal based on a comparison between the cumulative anomaly count and the stage-specific anomaly count threshold.

In this way, dynamic anomaly detection is performed based on the overall operating condition of the equipment (e.g., its health status), and equipment's usage stage (such as its life cycle) is evaluated based on sensor data from the equipment to dynamically adjust the sensitivity of the anomaly warning, such as giving appropriate anomaly warning thresholds according to different usage stages to more accurately identify equipment anomaly situations that require a warning, helping to reduce misjudgments or omissions of anomalies. Examples are given below, but are not limited to the description here.

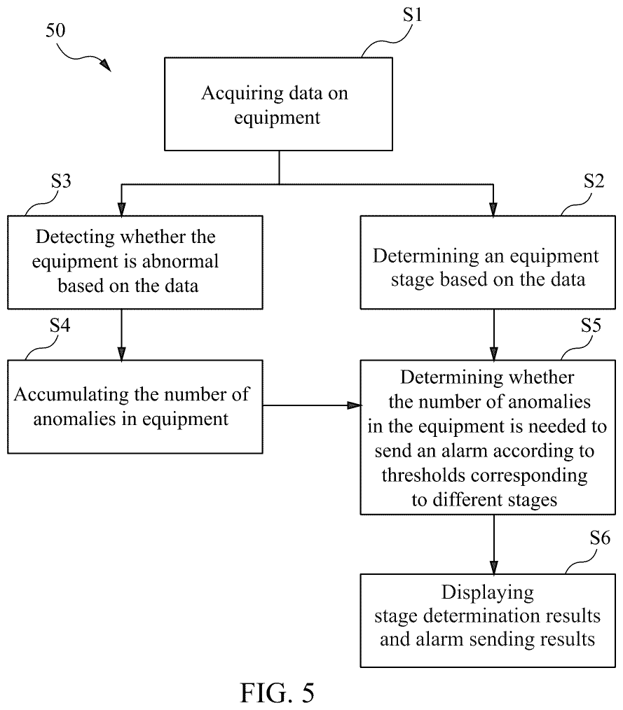

For example, FIG. 5 illustrates a method example 50, including steps S1 to S6. Step S1 is used for collecting data on the equipment, such as sensing values, data, or signals that can be used to detect aging factors, which can be a single signal or multiple sets of signals. In addition, equipment aging data analysis and exploration may be performed, including but not limited to data processing, feature extraction, and feature filtering, can also be performed. Then, steps S2 and S3 can be performed.

As shown in FIG. 5, step S2 is used for determining an equipment stage (such as an early stage, a middle stage, or a late stage) based on the data. For example, equipment health determination analysis is performed to use signals of key aging factors to establish an equipment health decline model that can be distinguished into three stages: the early stage (such as a health stage, e.g., the health period R1 shown in FIG. 3), the middle stage (such as a decline period or an aging period, e.g., the transition period R2 shown in FIG. 3), or the late stage (such as a dangerous stage, e.g., the wear period R3 shown in FIG. 3). The model outputs the current status of the equipment belonging to one of the three stages in real-time, and then step S5 can be performed.

As shown in FIG. 5, step S3 is used for detecting whether the equipment is abnormal based on the data. For example, an equipment anomaly detection analysis is performed to monitor signals for key aging factors and establish an anomaly detection model. The anomaly detection model then identifies sudden abnormal conditions in the equipment—such as signals that are suddenly rising, suddenly dropping, and increasing variability—to enable outputting anomaly detection results in real-time and then step S4 can be performed.

As shown in FIG. 5, step S4 is used for accumulating the number of anomalies in the equipment. For example, a counter adds up those determined as anomalies among detection results within a specific period. Then, step S5 can be performed.

As shown in FIG. 5, step S5 is used for determining whether the number of anomalies in the equipment is needed to send an alarm (such as issuing or not issuing a warning signal) according to thresholds corresponding to different stages. For example, the current equipment stage is obtained, and a threshold corresponding to the current equipment stage is given as the basis for determination, e.g., if it is determined that the threshold is exceeded, an alarm (such as a warning signal) is sent, and then step S6 can be performed.

As shown in FIG. 5, step S6 is used for displaying stage determination results and alarm sending results, e.g., displaying information such as the current stage or health level of the equipment, along with details derived from the alarm (e.g., the warning signal), is presented on the human-machine interface.

A piece of petrochemical process equipment is taken as an example. Key detection objects include bearings/motors of process reactors, cooling systems (such as fans/ice machines), and other equipment with rotating functions required for chemical processes.

For example, signals of the equipment aging factors can be some values measured by sensors or a combination thereof, such as a vibration value (e.g., an RMS value representing an average vibration energy over a period), a current value, a torque value, a stress value, and a pressure value. The signals of the equipment aging factors have a positive or negative correlation with the applicable stage, health level, or service life of the equipment. For example, during an online detection process, if a value representing the signal of the aging factor is less than a health threshold for the aging factor, the equipment can be classified as being in an early stage (i.e., a health stage). Conversely, if the value representing the signal of the aging factor is greater than or equal to the health threshold for the aging factor, a time-series analysis model can be activated to analyze or predict data trends using time-series data (such as sensing values). Models such as AR, MA, ARMA, ARIMA, and LSTM can be used to evaluate the current and near-term (future) health of the equipment, analyze and determine whether the current equipment stage belongs to a health stage, an middle stage, or a late stage.

The equipment anomaly warning method provided in the embodiments of the present disclosure can be adaptively used for functions of embodiments of the equipment anomaly warning system mentioned above. Correspondingly, embodiments of the equipment anomaly warning method are summarized as follows.

In some embodiments, in the equipment anomaly warning method, the detecting the cumulative anomaly count based on the set of sensing parameters to send the warning signal based on the comparison result of the cumulative anomaly count and the stage-specific anomaly count threshold includes: determining whether an anomaly state occurs based on a plurality of discrete-time sensing parameters in the set of sensing parameters and an anomaly threshold; counting occurrences of the anomaly state occurring in a period as the cumulative anomaly count; and determining whether the cumulative anomaly count exceeds the stage-specific anomaly count threshold; if the cumulative anomaly count exceeds the stage-specific anomaly count threshold, the warning signal is sent; otherwise, no warning signal is sent.

In some embodiments, in the equipment anomaly warning method, the set of sensing parameters includes at least one discrete-time sensing parameter of a petrochemical process equipment; for example, the at least one discrete-time sensing parameter comprises at least one of a vibration value, a stress value, a torque value, a pressure value, and a temperature value of the petrochemical process equipment.

In some embodiments, in the equipment anomaly warning method, the evaluating the stage-specific anomaly count threshold for the equipment based on the set of sensing parameters includes: determining an equipment stage parameter based on an equipment model and the set of sensing parameters, e.g., selecting a time-series analysis model generated based on the set of sensing parameters corresponding to a plurality of stages of the equipment to be the equipment model, such as selecting a model trained based on one of autoregression (AR), moving average (MA), autoregression moving average (ARMA), autoregression integrated moving average (ARIMA), and long short-term memory (LSTM) algorithms to be the time-series analysis model, as well as inputting the set of sensing parameters into the equipment model and setting the equipment stage parameter to one of a plurality of usage stage codes according to an output result of the equipment model; and determining the stage-specific anomaly count threshold based on the equipment stage parameters.

In some embodiments, in the equipment anomaly warning method, the detecting the cumulative anomaly count based on the set of sensing parameters to send the warning signal based on the comparison result of the cumulative anomaly count and the stage-specific anomaly count threshold includes: selectively displaying at least one of equipment-stage information associated with the stage-specific anomaly count threshold and anomaly-warning information associated with the warning signal on a human-machine interface.

In some embodiments, the equipment anomaly warning method further includes: storing the set of sensing parameters, the stage-specific anomaly count threshold, and the warning signal in the data device.

Embodiments of systems and methods for warning anomalies of equipment of the present disclosure are provided for acquiring the set of sensing parameters of the equipment, evaluating the stage-specific anomaly count threshold for the equipment based on the set of sensing parameters, and detecting the cumulative anomaly count based on the set of sensing parameters to send the warning signal based on the comparison result of the cumulative anomaly count and the stage-specific anomaly count threshold. In this way, dynamic anomaly detection is performed based on the overall operating condition of the equipment (e.g., its health status), and equipment's usage stage (such as its life cycle) is evaluated based on sensor data from the equipment to dynamically adjust the sensitivity of the anomaly warning, such as giving appropriate anomaly warning thresholds according to different periods to more accurately identify equipment anomaly situations that require a warning, helping to reduce misjudgments or omissions of anomalies.

Although the present disclosure has been disclosed in preferred embodiments, any person ordinarily skilled in the art can make various changes and modifications without departing from the spirit and scope of the present disclosure. Therefore, the protection scope of the present disclosure shall be determined by the appended claims.

What is claimed is:

1. An equipment anomaly warning system, comprising:
a sampling module configured to acquire a set of sensing parameters of a piece of equipment;
an evaluation module coupled to the sampling module, wherein the evaluation module is configured to evaluate a stage-specific anomaly count threshold for the equipment based on the set of sensing parameters; and
a determination module coupled to the sampling module and the evaluation module, wherein the determination module is configured to detect a cumulative anomaly count based on the set of sensing parameters to send a warning signal based on a comparison between the cumulative anomaly count and the stage-specific anomaly count threshold.

2. The equipment anomaly warning system as claimed in claim 1, wherein the determination module comprises:
a detecting unit configured to determine whether an anomaly state occurs based on a plurality of discrete-time sensing parameters in the set of sensing parameters and an anomaly threshold;
a counting unit configured to count occurrences of the anomaly state occurring in a period as the cumulative anomaly count; and
a signaling unit configured to determine whether the cumulative anomaly count exceeds the stage-specific anomaly count threshold;
wherein, if the cumulative anomaly count exceeds the stage-specific anomaly count threshold, the warning signal is sent; otherwise, no warning signal is sent.

3. The equipment anomaly warning system as claimed in claim 2, wherein the set of sensing parameters comprises at least one discrete-time sensing parameter of a petrochemical process equipment.

4. The equipment anomaly warning system as claimed in claim 3, wherein the at least one discrete-time sensing parameter comprises at least one of a vibration value, a stress value, a torque value, a pressure value, and a temperature value of the petrochemical process equipment.

5. The equipment anomaly warning system as claimed in claim 1, wherein the evaluation module comprises:
a stage-determining unit configured to determine an equipment stage parameter based on an equipment model and the set of sensing parameters; and
a threshold assignment unit configured to determine the stage-specific anomaly count threshold based on the equipment stage parameters.

6. The equipment anomaly warning system as claimed in claim 5, wherein the equipment model is a time-series analysis model generated based on the set of sensing parameters corresponding to a plurality of stages of the equipment.

7. The equipment anomaly warning system as claimed in claim 6, wherein the time-series analysis model is a model trained based on one of autoregression (AR), moving average (MA), autoregression moving average (ARMA), autoregression integrated moving average (ARIMA), and long short-term memory (LSTM) algorithms.

8. The equipment anomaly warning system as claimed in claim 5, wherein the stage-determining unit is configured to input the set of sensing parameters into the equipment model and set the equipment stage parameter to one of a plurality of usage stage codes according to an output result of the equipment model.

9. The equipment anomaly warning system as claimed in claim 1, further comprising a human-machine interface, wherein at least one of following is selectively displayed on the human-machine interface: (a) equipment stage information associated with the stage-specific anomaly count threshold, or (b) anomaly-warning information associated with the warning signal.

10. The equipment anomaly warning system as claimed in claim 1, further comprising a data device configured to store the set of sensing parameters, the stage-specific anomaly count threshold, and the warning signal, wherein each of the sampling module, the evaluation module, and the determination module comprises a transmission interface communicatively coupled to the data device.

11. An equipment anomaly warning method, applied to a system comprising a processor configured to execute the method, wherein the method comprises:
acquiring a set of sensing parameters of a piece of equipment;
evaluating a stage-specific anomaly count threshold for the equipment based on the set of sensing parameters; and
detecting a cumulative anomaly count based on the set of sensing parameters to send a warning signal based on a comparison between the cumulative anomaly count and the stage-specific anomaly count threshold.

12. The equipment anomaly warning method as claimed in claim 11, wherein the detecting the cumulative anomaly count based on the set of sensing parameters to send the warning signal based on the comparison result of the cumulative anomaly count and the stage-specific anomaly count threshold comprises:
determining whether an anomaly state occurs based on a plurality of discrete-time sensing parameters in the set of sensing parameters and an anomaly threshold;
counting occurrences of the anomaly state occurring in a period as the cumulative anomaly count; and
determining whether the cumulative anomaly count exceeds the stage-specific anomaly count threshold; if the cumulative anomaly count exceeds the stage-specific anomaly count threshold, the warning signal is sent; otherwise, no warning signal is sent.

13. The equipment anomaly warning method as claimed in claim 12, wherein the set of sensing parameters comprises at least one discrete-time sensing parameter of a petrochemical process equipment.

14. The equipment anomaly warning method as claimed in claim 13, wherein the at least one discrete-time sensing parameter comprises at least one of a vibration value, a stress value, a torque value, a pressure value, and a temperature value of the petrochemical process equipment.

15. The equipment anomaly warning method as claimed in claim 11, wherein the evaluating the stage-specific anomaly count threshold for the equipment based on the set of sensing parameters comprises:
determining an equipment stage parameter based on an equipment model and the set of sensing parameters; and
determining the stage-specific anomaly count threshold based on the equipment stage parameters.

16. The equipment anomaly warning method as claimed in claim 15, wherein the determining the equipment stage parameter based on the equipment model and the set of sensing parameters comprises:
selecting a time-series analysis model generated based on the set of sensing parameters corresponding to a plurality of stages of the equipment to be the equipment model.

17. The equipment anomaly warning method as claimed in claim 16, wherein the selecting the time-series analysis model generated based on the set of sensing parameters corresponding to a plurality of stages of the equipment to be the equipment model comprises:
selecting a model trained based on one of autoregression (AR), moving average (MA), autoregression moving average (ARMA), autoregression integrated moving average (ARIMA), and long short-term memory (LSTM) algorithms to be the time-series analysis model.

18. The equipment anomaly warning method as claimed in claim 15, wherein the determining the equipment stage parameter based on the equipment model and the set of sensing parameters comprises:
inputting the set of sensing parameters into the equipment model and setting the equipment stage parameter to one of a plurality of usage stage codes according to an output result of the equipment model.

19. The equipment anomaly warning method as claimed in claim 11, wherein the detecting the cumulative anomaly count based on the set of sensing parameters to send the warning signal based on the comparison result of the cumulative anomaly count and the stage-specific anomaly count threshold comprises:
selectively displaying at least one of following is selectively displayed on the human-machine interface: (a) equipment stage information associated with the stage-specific anomaly count threshold, or (b) anomaly-warning information associated with the warning signal.

20. The equipment anomaly warning method as claimed in claim 11, further comprising:
storing the set of sensing parameters, the stage-specific anomaly count threshold, and the warning signal in a data device.
